(19) United States
(12) Patent Application Publication
(10) Pub. No.: US 2011/0290646 A1
(43) Pub. Date: Dec. 1, 2011

(54) WAFER DEFECT ANALYZING APPARATUS, ION ABSTRACTION APPARATUS FOR SAME, AND WAFER DEFECT ANALYZING METHOD USING SAME

(76) Inventor: Ho Han, Gyeonggi-do (KR)

(21) Appl. No.: 13/148,254

(22) PCT Filed: Feb. 17, 2010
(86) PCT No.: PCT/KR2010/000973

§ 371 Date: Aug. 5, 2011

(30) Foreign Application Priority Data
Feb. 17, 2009 (KR) 10-2009-0012853

(51) Int. Cl. G01N 27/416

(52) U.S. Cl. 204/434

(57) ABSTRACT

Disclosed herein are a wafer defect analysis apparatus, an ion extraction device used therein and a wafer defect analysis method using the same, which separate a decoration process and an ion extraction process from each other during decoration of defective regions of a wafer and circulate an electrolyte in the ion extraction device, in which ion extraction has been completed, thus minimizing time consumed for the decoration process, thereby greatly reducing an overall time taken to perform decoration and thus shortening a wafer defect analysis time and improving efficiency of defect analysis. The wafer defect analysis apparatus, the ion extraction device used therein and the wafer defect analysis method using the same improve activity of ions during extraction of the ions for the decoration process, thereby considerably shortening an ion extraction time.

### BACKGROUND OF THE INVENTION

1. Field of the Invention

The present invention relates to a wafer defect analysis apparatus, an ion extraction device used therein and a wafer defect analysis method using the same, and more particularly to a wafer defect analysis apparatus which allows defects formed on the surface of a wafer provided with an oxide film to be confirmed with the naked eye so as to easily analyze the defects on the wafer, an ion extraction device used therein and a wafer defect analysis method using the same.

2. Description of the Related Art

In general, as semiconductor devices have become increasingly integrated and miniaturized, a thickness of an oxide film formed on the surface of a wafer has become increasingly smaller and a defect rate has increased. Therefore, improvement in quality of the wafer by means of process improvement through defect analysis of the surface of the wafer is necessary in relation to yield and reliability of semiconductor products.

Conventionally, in order to detect defects on a wafer surface, the defects on the wafer surface were observed at magnification of hundreds of thousands to millions of times and analyzed using expensive equipment, such as scanning electron microscopes (SEMs) or transmission electron microscopes (TEMs).

However, SEMs or TEMs are very expensive, and require a long analysis time and require highly skilled technicians to operate them.

Therefore, a wafer defect analysis apparatus, which achieves absorption of metal ions to defective regions of an oxide film (hereinafter, will referred to as “decoration”) by applying an electric field to a wafer on which the oxide film is grown so that states or positions of defects on the oxide film can be easily confirmed with the naked eye and the number of the defects is confirmed using a general electron microscope or a counting device, has been developed.

However, such a wafer defect analysis apparatus is disadvantageous in that time taken to prepare an electrolyte containing copper ions by ionizing copper is excessively long and absorption of copper ions to the defects on the surface of the wafer requires a complicated process.

That is, since wafers are processed one by one, after an absorption process of copper ions to one wafer has been completed, the electrolyte is discarded and the inside of the apparatus is washed. Then, after new electrolyte is put into the apparatus in order to process the next wafer and copper is ionized, the next wafer is loaded into the apparatus and decoration of the next wafer is performed. Therefore, the complicated process requiring a long time is repeated, and thus defect analysis of the overall wafers requires an excessively long time.

### SUMMARY OF THE INVENTION

Therefore, the present invention has been made in view of the above problems, and it is an object of the present invention to provide a wafer defect analysis apparatus, an ion extraction device used therein and a wafer defect analysis method using the same, which separate a decoration process and an ion extraction process from each other during decoration of defective regions of a wafer and circulate an electrolyte within the ion extraction device, in which ion extraction has been completed, thus minimizing time consumed for the complicated decoration process, thereby greatly reducing an overall time taken to perform decoration and thus shortening a wafer defect analysis time and improving efficiency of defect analysis.

It is another object of the present invention to provide a wafer defect analysis apparatus, an ion extraction device used therein and a wafer defect analysis method using the same, which improve activity of ions during extraction of the ions for the decoration process, thereby considerably shortening an ion extraction time.

In accordance with the present invention, the above and other objects can be accomplished by the provision of a wafer defect analysis apparatus including a decoration device accommodating a designated electrolyte, including a first electrode unit and a second electrode unit, and forming an electric field between the first electrode unit and the second electrode unit so as to achieve ion absorption at defective regions of a wafer mounted on the first electrode unit, an ion extraction device accommodating the designated electrolyte, and including a first electrode unit and second electrode unit and a source plate to supply designated ions to the electrolyte by an electric field formed between the first electrode unit and the second electrode unit, and a circulation device supplying the electrolyte discharged from the decoration device to the ion extraction device and supplying the electrolyte in the ion extraction device, in which ion extraction has been completed, to the decoration device so as to circulate the electrolyte.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view of a wafer defect analysis apparatus in accordance with one embodiment of the present invention;

FIGS. 2 and 3 are perspective views illustrating various examples of a source plate of the wafer defect analysis apparatus in accordance with the embodiment of the present invention;

FIGS. 4 to 9 are views schematically illustrating wafer defect analysis apparatuses in accordance with various embodiments of the present invention; and

FIGS. 10 to 11 are flow charts illustrating wafer defect analysis methods in accordance with embodiments of the present invention.

### DETAILED DESCRIPTION OF THE INVENTION

Hereinafter, detailed embodiments of a wafer defect analysis apparatus, an ion extraction device used therein and a wafer defect analysis method using the same in accordance with the present invention will be described with reference to the accompanying drawings.

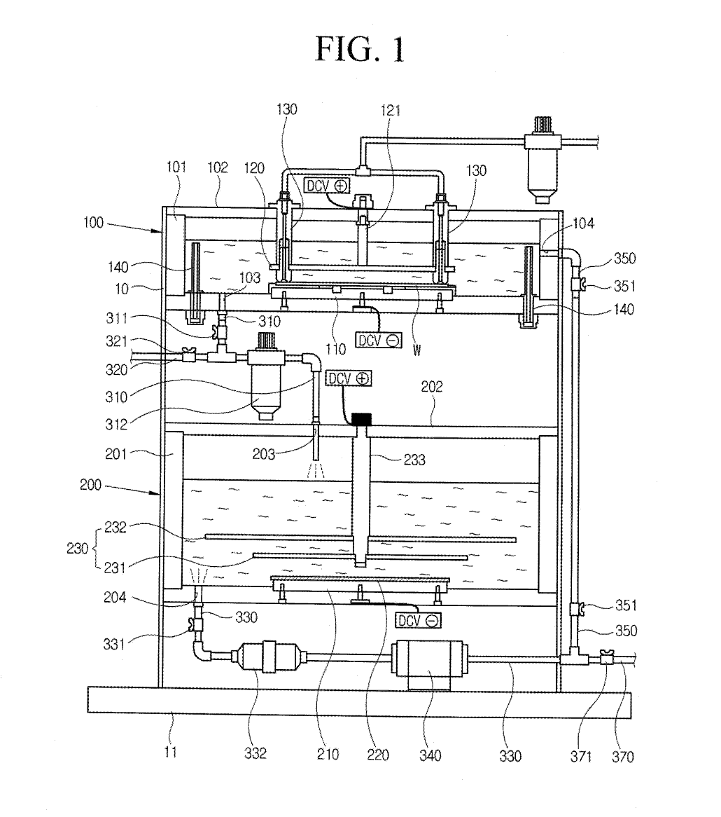

First, a wafer defect analysis apparatus in accordance with one embodiment of the present invention will be described with reference to FIG. 1. FIG. 1 is a schematic cross-sectional view of the wafer defect analysis apparatus in accordance with one embodiment of the present invention.

As shown in FIG. 1, the wafer defect analysis apparatus in accordance with this embodiment includes a decoration device 100, an ion extraction device 200 and a circulation device.

Although the embodiment shown in FIG. 1 describes the decoration device 100 and the ion extraction device 200 as being located on the upper portion and the lower portion of one housing 10 provided on a base 11, the positions of the decoration device 100 and the ion extraction device 200 are not limited thereto but the decoration device 100 and the ion extraction device 200 may be located on separate housings and then be connected to each other.

The decoration device 100 is a device, which allows designated ions to be absorbed to defective regions of the surface of a wafer (correctly speaking, a wafer provided with an oxide layer deposited or formed on the surface thereof. Here, the “wafer” means a wafer provided with an oxide layer formed on the surface thereof), i.e., which performs decoration of the wafer.

Here, the ions may be copper ions (Cu²⁺), or may be other metal ions having physical and chemical properties similar to the copper ions.

As shown in FIG. 1, the decoration device 100 preferably includes a decoration housing 101 to accommodate an electrolyte containing the designated ions for decoration, and a top cover 102 to cover the upper end of the decoration housing 101.

The decoration device 100 further includes a first electrode unit 110 and a second electrode unit 120 located at a position opposite to the first electrode unit 110 so that an electric field may be formed between the first electrode unit 110 and the second electrode unit 120.

The first electrode unit 110 is preferably provided in the shape of a plate, as shown in FIG. 1 and the second electrode unit 120 is preferably connected to an electrode connection member 121 and fixed to the top cover 102.

Although the embodiment shown in FIG. 1 describes the second electrode unit 120 as being fixed to a chucking device 130, the second electrode unit 120 may be provided separately from the chucking device 130.

The chucking device 130 serves to chuck a wafer W and then to load the wafer W on the upper surface of the first electrode unit 110. The chucking device 130 may be provided in a vacuum chuck, as shown in FIG. 1, and be in other types.

Therefore, when the chucking device 130 chucks the wafer W and then loads the wafer W on the upper surface of the first electrode unit 110, the wafer W is located between the first electrode unit 110 and the second electrode unit 120, and when an electric field is formed between the first electrode unit 110 and the second electrode unit 120, the ions contained in the electrolyte are absorbed to defective regions of the surface of the wafer W, thereby achieving decoration of the wafer W.

Preferably, the ions contained in the electrolyte within the decoration housing 101 are uniformly distributed in the electrolyte. In order to uniformly distribute the ions in the electrolyte, it is necessary to increase activity of the ions.

In order to increase activity of the ions, a method in which designated energy is transferred to the electrolyte within the decoration housing 101 may be used. Here, if the electrolyte is severely agitated during energy transfer, ion absorption to the defective regions of the wafer W may not be uniformly carried out.

Therefore, a method in which designated heat is applied to the electrolyte within the decoration housing 101 to increase temperature of the electrolyte so as to increase activity of the ions is preferably used. For this purpose, heaters 140 are preferably installed in the decoration housing 101, as shown in FIG. 1.

On the other hand, the ion extraction device 200 is a device to extract ions and then to supply the extracted ions to the electrolyte to be supplied to the decoration device 100.

As shown in FIG. 1, the ion extraction device 200 preferably includes an ion extraction housing 201 to accommodate a designated electrolyte, and a cover 202 to cover the upper end of the ion extraction housing 201.

The ion extraction device 200 further includes a first electrode unit 210 and a second electrode unit 233 located at a position opposite to the first electrode unit 210 so that an electric field may be formed between the first electrode unit 210 and the second electrode unit 233.

The first electrode unit 210 is preferably provided in the shape of a plate, as shown in FIG. 1 and the second electrode unit 233 is preferably provided in the shape of electrode pole provided with one end fixed to the cover 202 and the other end to which a source plate 230 to supply ions is fixed.

The source plate 230 includes a material from which ions are extracted so as to be supplied to the electrolyte within the ion extraction housing 201. For example, if extraction of copper ions is required, the entirety or a part of the source plate 230 includes copper.

Further, the source plate 230 may include one plate fixed to the second electrode unit 233, or include a plurality of sub-plates 231 and 232 fixed to the second electrode unit 233, as shown in FIG. 1.

A detailed description of the source plate 230 will be given later.

An insulating member 220 made of an electrically non-conductive material is preferably provided on the upper surface of the first electrode unit 210. Here, the insulating member 220 is provided so as to cover the entirety or a part of the upper surface of the plate-type first electrode unit 210.

If the insulating member 220 completely covers the entirety of the first electrode unit 210, an electric field may not be formed between the first electrode unit 210 and the second electrode unit 233. Therefore, the insulating member 220 is preferably provided so as to cover the first electrode unit 210 such that a designated part of the first electrode unit 210 is exposed to the electrolyte and thus the electric field can be formed between the first electrode unit 210 and the second electrode unit 233.

Because, if the electric field is formed between the first electrode unit 210 and the second electrode unit 233 under the condition that the first electrode unit 210 is completely exposed to the electrolyte, ions separated from the source plate 230 are concentrated upon and absorbed to the first electrode 210, and thus it is difficult to uniformly distribute the extracted ions in the electrolyte.

The circulation device of the wafer defect analysis apparatus in accordance with the present invention serves to supply the electrolyte discharged from the decoration device 100 to the ion extraction device 200 and to supply the electrolyte in the ion extraction device 200, in which ion extraction has been completed, to the decoration device 100, thereby circulating the electrolyte.

The circulation device includes a drain unit and a supply unit. The drain unit connects the decoration device 100 and the ion extraction device 200 so that the electrolyte is discharged from the decoration device and is then supplied to the ion extraction device 200.

The supply unit connects the ion extraction device 200 and the decoration device 100 so that the electrolyte in the ion extraction device 200, in which ion extraction has been completed, is supplied to the decoration device 100.

As shown in FIG. 1, an outflow hole 103 to drain the electrolyte within the decoration housing 101 is preferably provided at one side of the decoration housing 101 of the decoration device 100, more preferably at one side of the bottom of the decoration housing 101, and a supply hole 203 is preferably provided at one side of the ion extraction device 200, more preferably at one side of the cover 202.

The drain unit preferably includes a drain pipe 310 to connect the outflow hole 103 of the decoration housing 101 and the supply hole 203 of the cover 202 so that the electrolyte within the decoration device 100 flows to the ion extraction device 200, and a drain valve 311 installed on the drain pipe 310 to control flow of the electrolyte along the drain pipe 310.

Further, as shown in FIG. 1, a drain filter 312 is preferably installed in the drain pipe 310. The drain filter 312 serves to filter out foreign substances which may be mixed with the electrolyte within the decoration housing 101.

Preferably, a supply pipe 320 is connected to one end of the drain pipe 310 and a supply valve 321 is installed on the supply pipe 320, as shown in FIG. 1. If the amount of the electrolyte within the ion extraction device 200 is insufficient or the current electrolyte needs to be replaced due to use of the electrolyte for a long time, new electrolyte is supplied through the supply pipe 320, and supply of the new electrolyte is controlled by the supply valve 321.

A discharge hole 204 to discharge the electrolyte within the ion extraction housing 201 is preferably provided at one side of the ion extraction housing 201, more preferably at one side of the bottom of the ion extraction housing 201.

Further, an inflow hole 104 to introduce the electrolyte from the ion extraction device 200 into the decoration housing 201 is preferably provided at one side of the decoration housing 101, more preferably at the side wall of the decoration housing 101.

As shown in FIG. 1, the supply unit preferably includes a discharge pipe 330, a discharge valve 331 installed on the discharge pipe 330, a supply pipe 350, adjustment valves 351 installed on the supply pipe 350, and a pumping device 340.

The discharge pipe 330 is connected to the discharge hole 204, thus allowing the electrolyte within the ion extraction housing 201 to be discharged through the discharge hole 204 and then to flow along the discharge pipe 330. The discharge valve 331 opens and closes the discharge pipe 330, thus controlling discharge of the electrolyte.

The supply pipe 350 is provided with one end connected to the discharge pipe 330 and the other end connected to the inflow hole 104, thus allowing the electrolyte flowing along the discharge pipe 330 to be pumped by the pumping device 340 and then to be supplied to the inside of the decoration housing 101. The adjustment valves 351 open and close the supply valve 350, thus controlling supply of the electrolyte.

One adjustment valve 351 may be installed so as to control flow of the electrolyte. Alternatively, two adjustment valves 351 are more preferably installed at both sides of the supply pipe 350 so as to control flow of the electrolyte along the supply pipe 350 at both sides of the supply pipe 350, as shown in FIG. 1.

The pumping device 340 may be provided at one side of the discharge pipe 330 or one side of the supply pipe 350 so that the electrolyte flowing along the discharge pipe 330 through the discharge hole 204 is supplied to the inside of the decoration housing 101 through the supply pipe 350 and the inflow hole 104.

Although FIG. 1 illustrates the pumping device 340 as being installed at a portion of the discharge pipe 330 close to the supply pipe 350, the position of the pumping device 340 is not limited thereto. That is, the pumping device 340 may be installed at a portion of the supply pipe 350 close to the discharge pipe 330.

Further, as shown in FIG. 1, a circulation filter 332 is preferably provided at one side of the discharge pipe 330 so as to filter out foreign substances from the electrolyte discharged from the ion extraction housing 201.

As shown in FIG. 1, an effluence pipe 370 is connected to the discharge pipe 330 and an effluence valve 371 is installed on the effluence pipe 370, and thus the electrolyte may be completely discharged from the ion extraction device 200 to the outside by controlling the effluence valve 371 when it is necessary to discharge the electrolyte from the ion extraction device 200 to the outside.

Now, operation and effects of the wafer defect analysis apparatus in accordance with the embodiment shown in FIG. 1 will be described.

First, if wafer defect analysis is necessary, the ion extraction device 200 of the wafer defect analysis apparatus of the present invention performs an ion extraction process in which ions are extracted from the source plate 230 so as to be sufficiently distributed into an electrolyte.

That is, when an electric field is formed between the first electrode unit 210 and the second electrode unit 233, ions serving as a source are extracted from the source plate 230 fixed to the second electrode unit 233 and are distributed into the electrolyte.

After the ion extraction process has been completed, the pumping device 340 is operated and the discharge valve 331 is opened so as to discharge the electrolyte to the discharge pipe 330. At this time, the adjustment valves 351 are opened so as to introduce the electrolyte flowing along the discharge pipe 330 to the inside of the decoration housing 101 via the supply pipe 350.

Once a sufficient amount of the electrolyte to perform decoration is introduced into the decoration housing 101, the pumping device 340 is turned off and both the discharge valve 331 and the adjustment valves 351 are closed.

At this time, the heaters 140 are preferably operated so as to heat the electrolyte to a designated temperature.

Thereafter, after the top cover 102 of the decoration device 100 is opened and a wafer W is chucked by the chucking device 130, the top cover 102 is closed. Here, the chucked wafer W is mounted on the first electrode unit 110.

When an electric field is formed between the first electrode unit 110 and the second electrode unit 120, the ions distributed in the electrolyte within the decoration housing 101 are absorbed to defective regions of the wafer W and thus decoration of the wafer W is performed.

After decoration of the wafer W has been completed, the wafer W is taken out of the decoration device 100, and the drain valve 311 is opened so as to drain the electrolyte within the decoration housing 101 to the drain pipe 310 through the outflow hole 103.

After flow of the electrolyte from the decoration device 100 to the ion extraction device 200 has been completed, the ion extraction device 200 performs the ion extraction process upon another wafer. Preferably, the ion extraction device 200 is operated before the drain process in the decoration device 100 is performed, thereby firstly performing the ion extraction process and then performing supply of the electrolyte simultaneously with the drain process, thus being capable of greatly reducing an overall time taken to perform decoration.

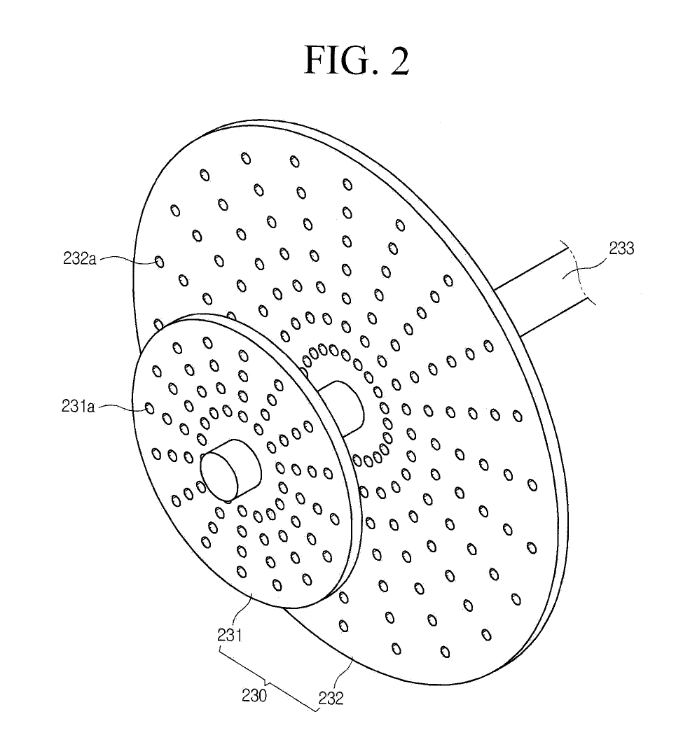

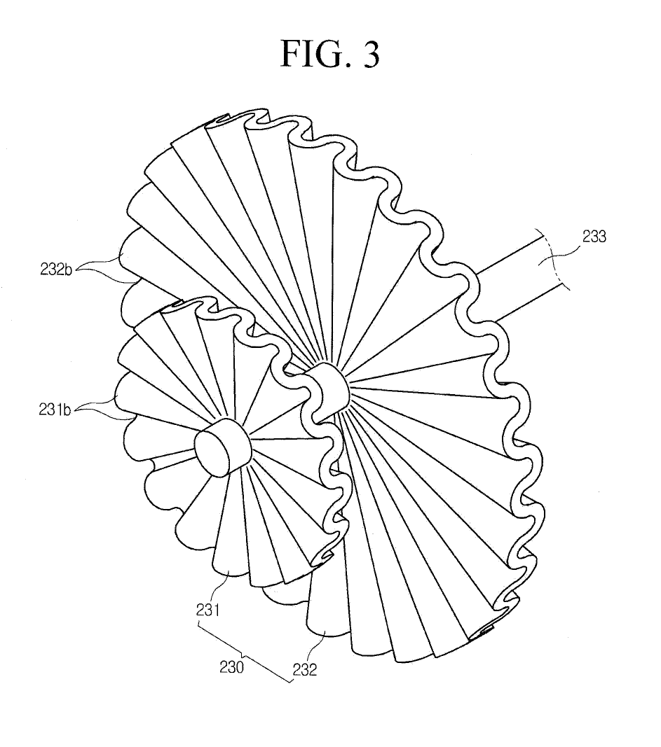

Hereinafter, the source plate 230 of the wafer defect analysis apparatus in accordance with this embodiment will be described in more detail with reference to FIGS. 2 and 3.

FIGS. 2 and 3 illustrate examples of the source plate 230 including a first sub-plate 231 and a second sub-plate 232.

In the example of the source plate 230 shown in FIG. 2, a plurality of first holes 231a is formed on the first sub-plate 231 and a plurality of second holes 232a is formed on the second sub-plate 232.

As described above, formation of the plurality of first holes 231a and second holes 232a may increase a surface area of parts of the source electrode 230 exposed to the electrolyte within the ion extraction device 200 (with reference to FIG. 1) and increase efficiency of extracting ions from the source plate 230.

In the example of the source plate 230 shown in FIG. 3, a plurality of first corrugated parts 231b is formed on the first sub-plate 231 and a plurality of second corrugated parts 232b is formed on the second sub-plate 232.

As described above, formation of the plurality of first corrugated parts 231b and second corrugated parts 232b may increase a surface area of parts of the source electrode 230 exposed to the electrolyte within the ion extraction device 200 and increase efficiency of extracting ions from the source plate 230.

The wafer defect analysis apparatus in accordance with the embodiment shown in FIG. 1 separates the ion extraction process and the decoration process from each other and performs the ion extraction process of the electrolyte to be used for decoration of the next wafer during the decoration process of the current wafer, thus having advantages, such as considerable reduction in an overall time taken to perform decoration. However, since time taken to perform the ion extraction process is longer than time taken to perform the decoration process, if the ion extraction process is performed for a shorter time, the overall time taken to perform decoration may be further reduced.

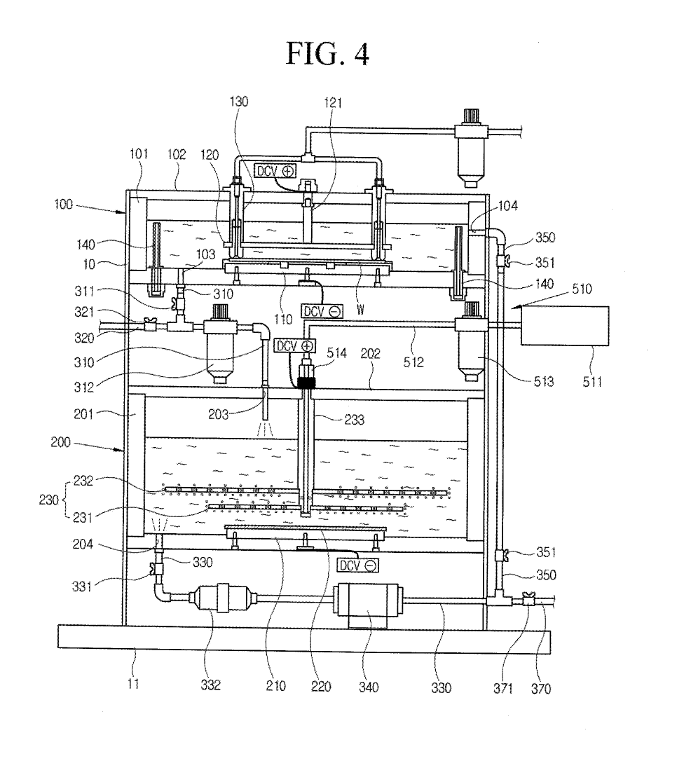

Respective embodiments shown in FIGS. 4 to 9 illustrate wafer defect analysis apparatuses which greatly reduce time taken to perform the ion extraction process in addition to all advantages of the wafer defect analysis apparatus in accordance with the embodiment shown in FIG. 1.

Each of the wafer defect analysis apparatuses in accordance with the respective embodiments shown in FIGS. 4 to 9 include an energy transfer unit to transfer designated energy to an electrolyte accommodated in an ion extraction device so as to increase activity of ions during ion extraction and thus to reduce time taken to perform the ion extraction process.

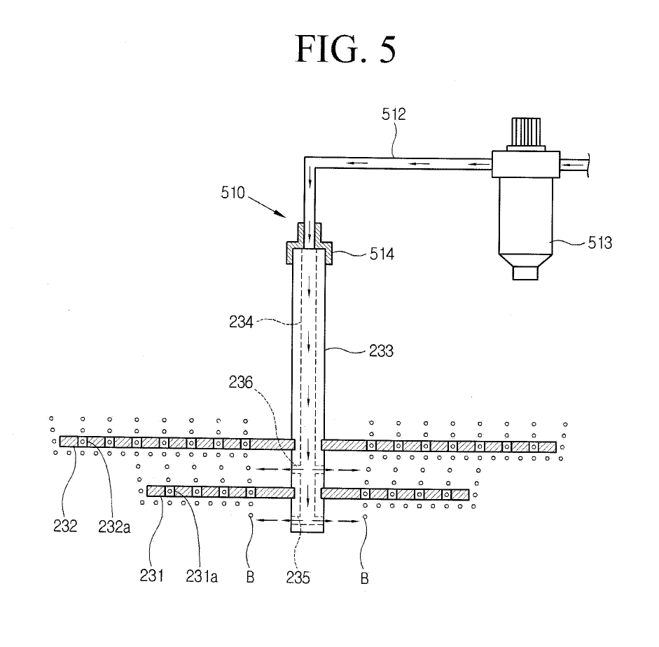

First, with reference to FIGS. 4 and 5, a wafer defect analysis apparatus with an energy transfer unit in accordance with another embodiment of the present invention will be described. FIG. 4 is a cross-sectional view of the wafer defect analysis apparatus in accordance with this embodiment and FIG. 5 is a view illustrating a part of an ion extraction device and a bubble generation unit as the energy transfer unit of the wafer defect analysis apparatus shown in FIG. 4.

As shown in FIGS. 4 and 5, the wafer defect analysis apparatus in accordance with this embodiment includes a decoration device 100, an ion extraction device 200 and a circulation device.

The decoration device 100, the ion extraction device 200 and the circulation device of this embodiment have configurations and functions which are substantially the same as those of the embodiment shown in FIG. 1, and a detailed description thereof will thus be omitted. Therefore, the energy transfer unit alone will now be described in detail.

As shown in FIG. 4, a bubble generation unit 510 as the energy transfer unit is provided on the ion extraction device 200 of the wafer defect analysis apparatus in accordance with this embodiment.

The bubble generation unit 510 supplies designated gas to an electrolyte accommodated within the ion extraction device 200 so as to generate bubbles B in the electrolyte.

Preferably, in order to prevent impurities from being introduced into the ion extraction device 200 or unnecessary ions from being generated within the electrolyte, clean air or N₂ gas is used as the designated gas.

As shown in FIGS. 4 and 5, the bubble generation unit 510 includes a gas supply unit 511 to accommodate injection to generate the bubbles B, and a gas pipe 512 to connect the gas supply unit 511 to a gas channel unit 234 provided within a second electrode unit 233 provided in the shape of an electrode pole.

Preferably, connection between the gas pipe 512 and the second electrode unit 233 is carried out using a connection unit 514, and a gas filter 513 is installed in the gas pipe 512 so as to filter out foreign substances from the gas supplied from the gas supply unit 511.

Therefore, as shown in FIG. 5, the gas supplied from the gas supply unit 511 flows along the gas channel unit 234 of the second electrode unit 233 via the gas pipe 512, and the gas flowing along the gas channel unit 234 is sprayed into the electrolyte through nozzle units 235 and 236, thereby generating the bubbles B.

Here, some of the bubbles B preferably pass through the first holes 231a and the second holes 232a respectively formed on the first sub-plate 231 and the second sub-plate 232, as shown in FIG. 5.

Preferably, the first sub-plate 231 is disposed below the second sub-plate 232, and the nozzle units 235 and 236 include a first nozzle unit 235 provided below the first sub-plate 231 and a second nozzle unit 236 provided between the first sub-plate 231 and the second sub-plate 232.

Further, a diameter of the first sub-plate 231 is preferably smaller than a diameter of the second sub-plate 232 so that the bubbles B sprayed from the first nozzle unit 235 and passed through the first sub-plate 231 may reach the second sub-plate 232, thereby increasing efficiency of extracting ions from the source plate 230.

When numerous bubbles B are generated by injecting gas from the bubble generation unit 510 into the electrolyte in such a manner, the bubbles B promote separation of ions from the surfaces of the first sub-plate 231 and the second sub-plate 232 and thus increase activity of the ions, thereby allowing the ions to be more rapidly extracted from the source plate 230.

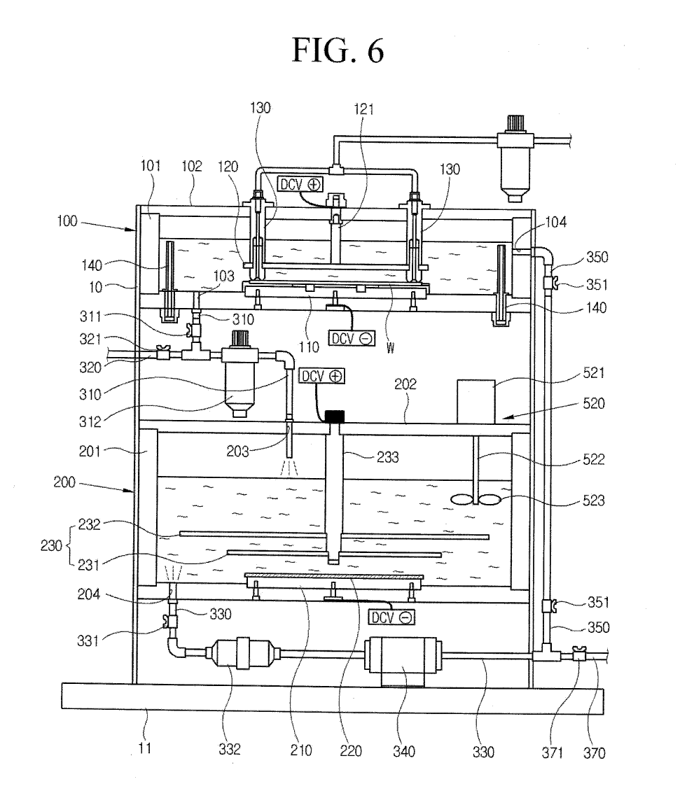

Further, the bubbles B prevent the ions within the electrolyte from being concentrated upon one side or being accumulated on the bottom, thereby allowing the extracted ions to be uniformly distributed within the electrolyte. Next, with reference to FIG. 6, a wafer defect analysis apparatus with an energy transfer unit in accordance with another embodiment of the present invention will be described.

As shown in FIG. 6, the wafer defect analysis apparatus in accordance with this embodiment includes a decoration device 100, an ion extraction device 200 and a circulation device.

The decoration device 100, the ion extraction device 200 and the circulation device of this embodiment have configurations and functions which are substantially the same as those of the embodiment shown in FIG. 1, and a detailed description thereof will thus be omitted. Therefore, the energy transfer unit alone will now be described in detail.

As shown in FIG. 6, a stirring unit 520 as the energy transfer unit is provided on the ion extraction device 200 of the wafer defect analysis apparatus in accordance with this embodiment.

The stirring unit 520 serves to stir an electrolyte accommodated within the ion extraction device 200, and thus prevents ions extracted from the source plate 230 from being concentrated upon one place or being accumulated on the bottom so as to increase uniformity of the ions in the electrolyte and increases activity of the ions so as to increase efficiency of extracting the ions from the source plate 230.

As shown in FIG. 6, the stirring unit 520 preferably includes a motor 521 to provide rotary force, a rotary shaft 522 of the motor 521, and a stirrer 523 installed at the end of the rotary shaft 522 and rotated together with rotation of the rotary shaft 522.

The stirrer 523 may be an impeller, a propeller or a fan, or be provided in any structure which effectively stirs the electrolyte.

The stirring unit 520 effectively stirs the electrolyte, as described above, and thus increases activity of the ions, thereby allowing the ions to be more rapidly extracted from the source plate 230.

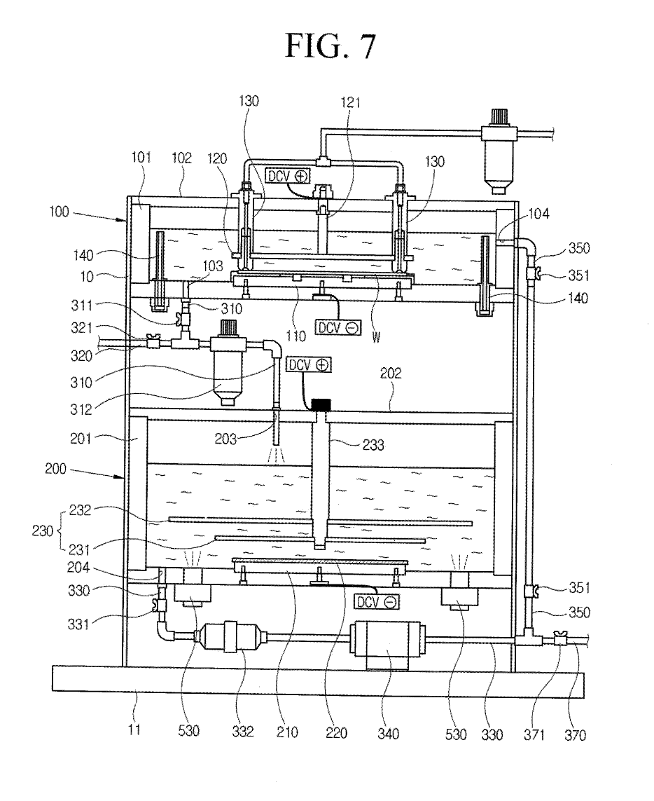

Further, the stirring unit 520 prevents the ions within the electrolyte from being concentrated upon one side or being accumulated on the bottom, thereby allowing the extracted ions to be uniformly distributed within the electrolyte. Next, with reference to FIG. 7, a wafer defect analysis apparatus with an energy transfer unit in accordance with another embodiment of the present invention will be described.

As shown in FIG. 7, the wafer defect analysis apparatus in accordance with this embodiment includes a decoration device 100, an ion extraction device 200 and a circulation device.

The decoration device 100, the ion extraction device 200 and the circulation device of this embodiment have configurations and functions which are substantially the same as those of the embodiment shown in FIG. 1, and a detailed description thereof will thus be omitted. Therefore, the energy transfer unit alone will now be described in detail.

As shown in FIG. 7, an ultrasonic unit 530 as the energy transfer unit is provided on the ion extraction device 200 of the wafer defect analysis apparatus in accordance with this embodiment.

When the ultrasonic unit 530 generates ultrasonic waves and transmits the ultrasonic waves to an electrolyte accommodated in the ion extraction device 200, numerous bubbles are generated due to vibration of the ultrasonic waves.

The bubbles B generated due to the ultrasonic waves in the electrolyte promote separation of ions from the surface of the source plate 230 and thus increase activity of the ions due to energy of the ultrasonic waves, thereby allowing the ions to be more rapidly extracted from the source plate 230.

Further, the bubbles prevent the ions within the electrolyte from being concentrated upon one side or being accumulated on the bottom, thereby allowing the extracted ions to be uniformly distributed within the electrolyte.

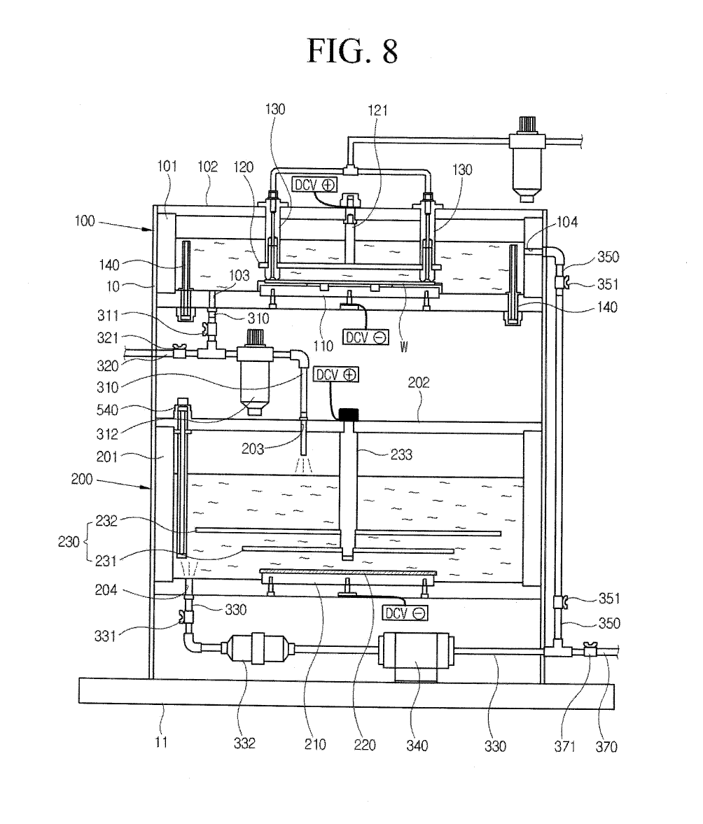

Next, with reference to FIG. 8, a wafer defect analysis apparatus with an energy transfer unit in accordance with another embodiment of the present invention will be described.

As shown in FIG. 8, the wafer defect analysis apparatus in accordance with this embodiment includes a decoration device 100, an ion extraction device 200 and a circulation device.

The decoration device 100, the ion extraction device 200 and the circulation device of this embodiment have configurations and functions which are substantially the same as those of the embodiment shown in FIG. 1, and a detailed description thereof will thus be omitted. Therefore, the energy transfer unit alone will now be described in detail.

As shown in FIG. 8, a heating unit 540 as the energy transfer unit is provided on the ion extraction device 200 of the wafer defect analysis apparatus in accordance with this embodiment.

The heating unit 540 transfers designated heat to an electrolyte accommodated in the ion extraction device 200 and thus increases temperature of the electrolyte so as to increase activity of ions.

When activity of the ions within the electrolyte is increased by increasing the temperature of the electrolyte using the heating unit 540, time taken to extract ions from the source plate 230 may be shortened.

Further, the heating unit 540 prevents the ions within the electrolyte from being concentrated upon one side or being accumulated on the bottom, thereby allowing the extracted ions to be uniformly distributed within the electrolyte.

Although not shown in the drawings, all of the above-described energy transfer units may be provided on the ion extraction device so as to more increase efficiency of extracting the ions from the source plate.

That is, two or more of the bubble generation unit, the stirring unit, the ultrasonic unit and the heating unit or all of them may be provided on the ion extraction device so as to very effectively and rapidly perform ion extraction.

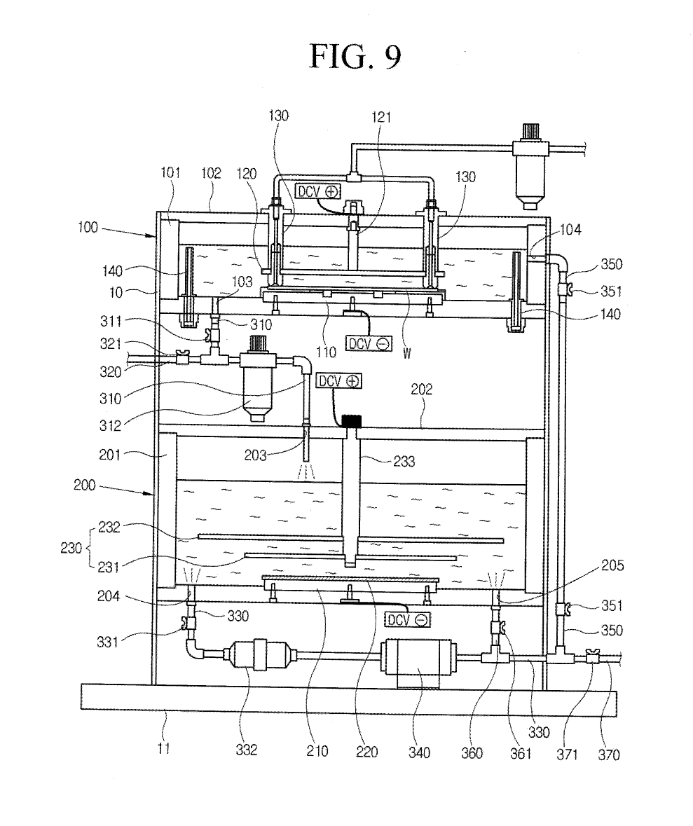

Next, with reference to FIG. 9, a wafer defect analysis apparatus in accordance with another embodiment of the present invention will be described. As shown in FIG. 9, the wafer defect analysis apparatus in accordance with this embodiment includes a decoration device 100, an ion extraction device 200 and a double circulation device.

The decoration device 100 and the ion extraction device 200 of this embodiment have configurations and functions which are substantially the same as those of the embodiment shown in FIG. 1, and a detailed description thereof will thus be omitted. Therefore, the double circulation device alone will now be described in detail.

The double circulation device supplies an electrolyte discharged from the decoration device 100 to the ion extraction device 200, connects both sides of the ion extraction device 200 so as to circulate the electrolyte within the ion extraction device 200, and supplies the electrolyte in the ion extraction device 200, in which ion extraction has been completed, to the decoration device 100, thereby circulating the electrolyte along two routes.

That is, the double circulation device allows the electrolyte to be circulated within the ion extraction device 200 and to be circulated between the ion extraction device and the decoration device 100, as needed, thereby circulating the electrolyte along the two routes.

Here, circulation of the electrolyte within the ion extraction device 200 is defined as first circulation and circulation of the electrolyte from the ion extraction device 200 to the decoration device 100 and from the decoration device 100 to the ion extraction device 200 is defined as second circulation.

In case of the first circulation, the electrolyte discharged from one side of the ion extraction device 200 is introduced into the other side of the ion extraction device 200, thus being circulated within the ion extraction device 200 itself.

Owing to the first circulation, the electrolyte within the ion extraction device 200 is circulated, and thus ions within the electrolyte may be uniformized without being concentrated upon one side or being accumulated on the bottom, and activity of the ions may be increased due to flow energy generated by flow of the electrolyte.

That is, the first circulation functions as the above-described energy transfer unit.

On the other hand, in case of the second circulation, the electrolyte is circulated through a method which is substantially the same as the circulation device of the wafer defect analysis apparatus in accordance with the embodiment shown in FIG. 1.

The double circulation device may be divided into a first circulation unit to circulate the electrolyte within the ion extraction device 200 through the first circulation, and a second circulation unit to circulate the electrolyte from the ion extraction device 200 to the decoration device 100 and from the decoration device 100 to the ion extraction device 200 through the second circulation, and the first circulation unit and the second circulation unit of the double circulation device may be separately provided.

If the first circulation unit and the second circulation unit of the double circulation device are separately provided, the first circulation unit and the second circulation unit respectively use separate pumping units and thus the double circulation device may be undesirable in terms of cost.

Therefore, the double circulation device preferably performs both the first circulation and the second circulation using one pumping device, as shown in FIG. 9.

In the wafer defect analysis apparatus in accordance with the embodiment shown in FIG. 9, the double circulation device includes a drain unit, a supply unit and a circulation unit.

The drain unit, as shown in FIG. 9, preferably includes a drain pipe 310 to connect the outflow hole 103 of the decoration housing 101 and the supply hole 203 of the cover 202 so that the electrolyte within the decoration device 100 flows to the ion extraction device 200, and a drain valve 311 installed on the drain pipe 310 to control flow of the electrolyte along the drain pipe 310.

Further, as shown in FIG. 9, a drain filter 312 is preferably installed in the drain pipe 310. The drain filter 312 serves to filter out foreign substances which may be mixed with the electrolyte within the decoration housing 101.

Preferably, a supply pipe 320 is connected to one end of the drain pipe 310 and a supply valve 321 is installed on the supply pipe 320, as shown in FIG. 9. If the amount of the electrolyte within the ion extraction device 200 is insufficient or the current electrolyte needs to be replaced due to use of the electrolyte for a long time, new electrolyte is supplied through the supply pipe 320, and supply of the new electrolyte is controlled by the supply valve 321.

The supply unit, as shown in FIG. 9, preferably includes a discharge pipe 330, a discharge valve 331 installed on the discharge pipe 330, a supply pipe 350, adjustment valves 351 installed on the supply pipe 350, and a pumping device 340.

The discharge pipe 330 is connected to the discharge hole 204 of the ion extraction device 200, thus allowing the electrolyte within the ion extraction device 200 to be discharged through the discharge hole 204 and then to flow along the discharge pipe 330. The discharge valve 331 opens and closes the discharge pipe 330, thus controlling discharge of the electrolyte.

The supply pipe 350 is provided with one end connected to the discharge pipe 330 and the other end connected to the inflow hole 104 of the decoration device 100, thus allowing the electrolyte flowing along the discharge pipe 330 to be pumped by the pumping device 340 and then to be supplied to the inside of the decoration housing 101. The adjustment valves 351 open and close the supply valve 350, thus controlling supply of the electrolyte.

One adjustment valve 351 may be installed so as to control flow of the electrolyte. Alternatively, two adjustment valves 351 are preferably installed at both sides of the supply pipe 350 so as to control flow of the electrolyte along the supply pipe 350 at both sides of the supply pipe 350, as shown in FIG. 9.

Further, as shown in FIG. 9, a circulation filter 332 is preferably provided at one side of the discharge pipe 330 so as to filter out foreign substances from the electrolyte discharged from the ion extraction housing 201.

Further, the circulation unit, as shown in FIG. 9, preferably includes a circulation pipe 360 provided with one end connected to the discharge pipe 330 and the other end connected to a circulation hole 205 provided at the other side of the ion extraction device 200 so as to circulate the electrolyte within the ion extraction device 200, and a circulation valve 361 installed on the circulation pipe 360 to control flow of the electrolyte along the circulation pipe 360.

Here, the circulation hole 205 is preferably formed at a position as distant from the discharge hole 204 as possible. The circulation hole 205 may be formed through the bottom of the ion extraction housing 201 of the ion extraction device 200, as shown in FIG. 9, or be formed through the side wall of the ion extraction housing 201.

The pumping device 340 is installed on the discharge pipe 330 so as to facilitate the first circulation of the electrolyte within the ion extraction device along the discharge pipe 330, and when the circulation valve 361 is closed, the pumping device 340 allows the electrolyte to flow along the discharge pipe 330 and the supply pipe 350 so as to perform the second circulation of the electrolyte.

As shown in FIG. 9, an effluence pipe 370 is connected to the discharge pipe 330 and an effluence valve 371 is installed on the effluence pipe 370, and thus the electrolyte may be completely discharged from the ion extraction device 200 to the outside by controlling the effluence valve 371 when it is necessary to discharge the electrolyte from the ion extraction device 200 to the outside.

Now, operation and effects of the wafer defect analysis apparatus in accordance with the embodiment shown in FIG. 9 will be described.

First, if wafer defect analysis is necessary, the ion extraction device 200 of the wafer defect analysis apparatus in accordance with this embodiment performs an ion extraction process in which ions are extracted from the source plate 230 so as to be sufficiently distributed into an electrolyte.

That is, when an electric field is formed between the first electrode unit 210 and the second electrode unit 233, ions serving as a source are extracted from the source plate 230 fixed to the second electrode unit 233 and are distributed into the electrolyte.

At this time, the pumping device 340 is operated and the discharge valve 331 and the circulation valve 361 are opened so as to perform the first circulation of the electrolyte within the ion extraction device. In this case, the adjustment valves 351 are kept closed.

If the ion extraction process is carried out while performing the first circulation, efficiency of extracting the ions from the source plate 230 is improved and thus time taken to perform ion extraction is considerably reduced.

After the ion extraction process has been completed, the circulation valve 361 is closed so as to stop the first circulation of the electrolyte and the adjustment valves 351 are opened so as to perform the second circulation of the electrolyte. Then, the electrolyte discharged from the ion extraction device 200 and flowing along the discharge pipe 300 is supplied to the decoration device 100 through the supply pipe 350.

Once a sufficient amount of the electrolyte to perform decoration is introduced into the decoration housing 101, the pumping device 340 is turned off and the discharge valve 331, the circulation valve 361 and the adjustment valves 351 are closed.

At this time, the heaters 140 are preferably operated so as to heat the electrolyte to a designated temperature.

Thereafter, after the top cover 102 of the decoration device 100 is opened and a wafer W is chucked by the chucking device 130, the top cover 102 is closed. Here, the chucked wafer W is mounted on the first electrode unit 110.

When an electric field is formed between the first electrode unit 110 and the second electrode unit 120, the ions distributed in the electrolyte within the decoration housing 101 are absorbed to defective regions of the wafer W and thus decoration of the wafer W is performed.

After decoration of the wafer W has been completed, the wafer W is taken out of the decoration device 100, and the drain valve 311 is opened so as to drain the electrolyte within the decoration housing 101 to the drain pipe 310 through the outflow hole 103.

After flow of the electrolyte from the decoration device 100 to the ion extraction device 200 has been completed, the ion extraction device 200 performs the ion extraction process upon another wafer. Preferably, the ion extraction device 200 is operated before the drain process in the decoration device 100 is performed, thereby firstly performing the ion extraction process and then performing supply of the electrolyte simultaneously with the drain process, thus being capable of considerably reducing an overall time taken to perform decoration.

Since the time taken to perform ion extraction is considerably reduced due to the first circulation of the electrolyte by the double circulation device, if decoration of a plurality of wafers is carried out, a delay time for decoration of each of the wafers may be considerably shortened.

In general, time taken to perform the ion extraction process is longer than time taken to perform the decoration process. Therefore, if the time taken to perform the ion extraction process is greatly reduced due to the double circulation device, the ion extraction device 200 carries out the ion extraction process while the decoration process of one wafer is carried out, and the ion extraction process is almost completed simultaneously with completion of the decoration process, thereby allowing the decoration process of the next wafer to be carried out without delay and thus greatly reducing the overall time taken to perform decoration.

Further, the energy transfer units of the wafer defect analysis apparatuses in accordance with the embodiments shown in FIGS. 4 to 8 may be applied to the wafer defect analysis apparatus in accordance with the embodiment shown in FIG. 9.

That is, at least one of the bubble generation unit shown in FIG. 4, the stirring unit shown in FIG. 6, the ultrasonic unit shown in FIG. 7, and the heating unit shown in FIG. 8 may be applied to the ion extraction device of the wafer defect analysis apparatus in accordance with the embodiment shown in FIG. 9 so as to be used during the first circulation of the electrolyte, thereby being capable of more greatly reducing the time taken for the ion extraction process in the ion extraction device.

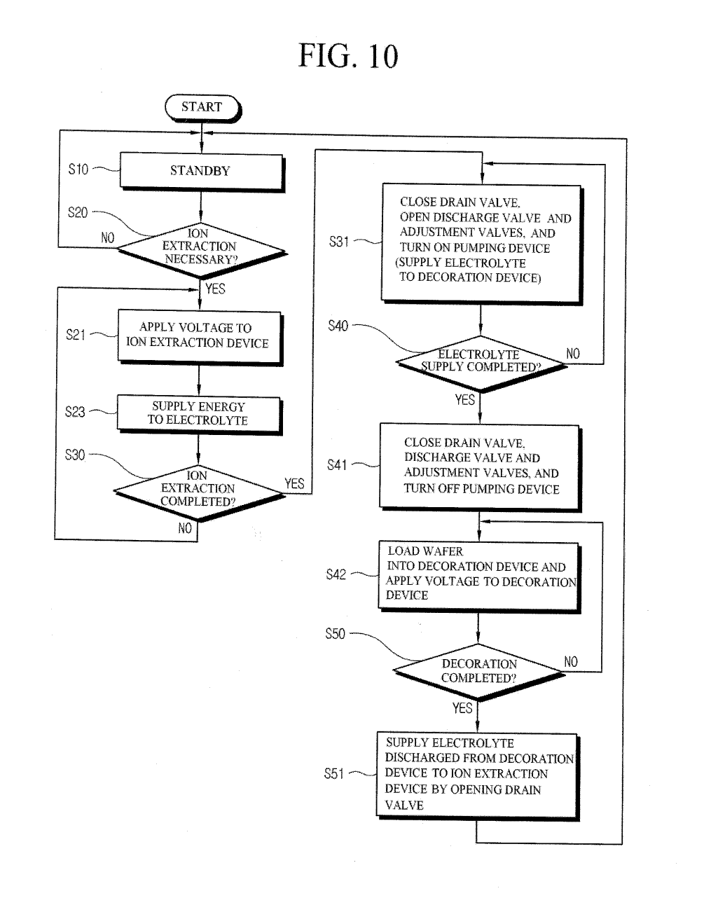

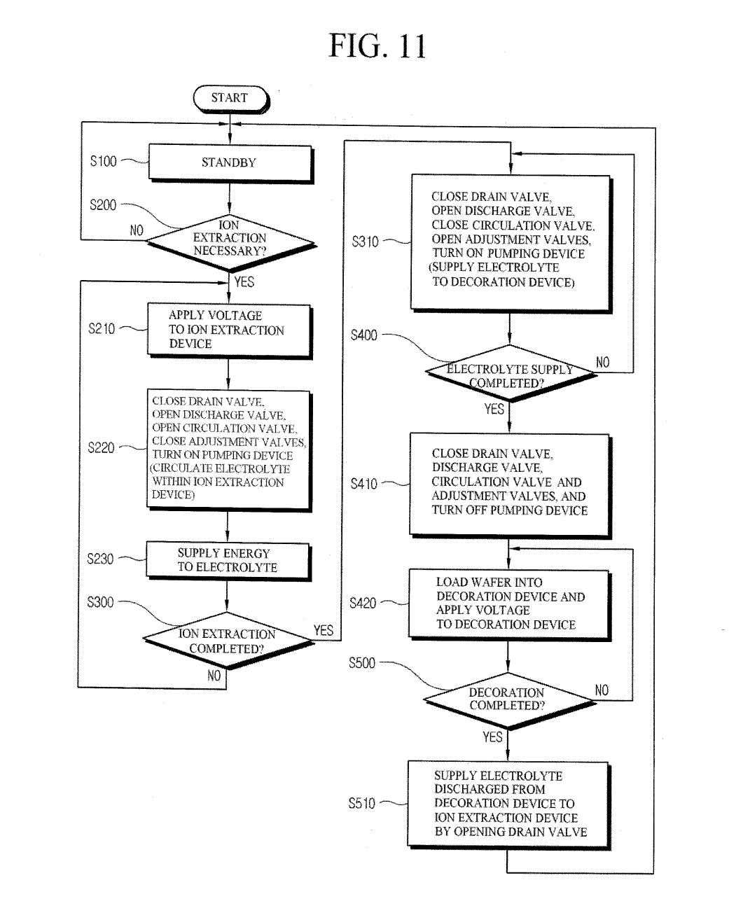

Hereinafter, with reference to FIGS. 10 and 11, wafer defect analysis methods using wafer defect analysis apparatuses in accordance with various embodiments of the present invention will be described.

A flow chart shown in FIG. 10 illustrates a wafer defect analysis method using the wafer defect analysis apparatus shown in each of FIGS. 1 to 8.

First, as shown in FIG. 10, the wafer defect analysis apparatus is in a standby state (Operation S10). Under this state, the drain valve, the discharge valve, the adjustment valves and the pumping device are turned off.

Thereafter, whether or not ion extraction to perform decoration of a wafer is necessary is judged (Operation S20).

Upon judging that ion extraction is necessary, voltage is applied to the ion extraction device (Operation 21) and the ion extraction device performs ion extraction. Here, if the ion extraction device is provided with an energy transfer unit, the energy transfer unit is operated so as to apply energy to an electrolyte accommodated in the ion extraction device (Operation S23).

Thereafter, whether or not ion extraction has been completed is judged (Operation S30). Upon judging that ion extraction has been completed, the discharge valve and the adjustment valves are opened and the pumping device is operated under the condition that the drain valve is closed so as to supply the electrolyte to the decoration device (Operation S31).

Thereafter, whether or not supply of the electrolyte has been completed is judged (Operation S40). Upon judging that supply of the electrolyte has been completed, the drain valve, the discharge valve and the adjustment valves are closed and the pumping device is turned off (Operation S41).

Thereafter, a target wafer is loaded into the decoration device and voltage is applied to the decoration device so as to perform decoration of the wafer (Operation S42).

Thereafter, whether or not decoration has been completed is judged (Operation S50). Upon judging that decoration has been completed, the drain valve is opened under the condition that the discharge valve and the adjustment valves are closed so as to supply the electrolyte discharged from the decoration device to the ion extraction device (Operation S51).

Although the flow chart shown in FIG. 10 illustrates the wafer defecting analysis method as being fed back to Operation S10 after Operation S51 so as to prepare decoration of the next wafer, Operation S51 and Operation S31 may be performed substantially simultaneously.

That is, simultaneously with supply of the electrolyte discharged from the decoration device to the ion extraction device by opening the drain valve in Operation S51, the discharge valve and the adjustment valves may be opened and the pumping device may be operated so as to supply the electrolyte within the ion extraction device to the decoration device in Operation S31.

Such a process is preferably carried out on the assumption that the ion extraction process for decoration of the next wafer is continuously performed while decoration of the current wafer is performed.

A flow chart shown in FIG. 11 illustrates a wafer defect analysis method using the wafer defect analysis apparatus shown in FIG. 9.

First, as shown in FIG. 11, the wafer defect analysis apparatus is in a standby state (Operation S100). Under this state, the drain valve, the discharge valve, the adjustment valves and the pumping device are turned off.

Thereafter, whether or not ion extraction to perform decoration of a wafer is necessary is judged (Operation S200).

Upon judging that ion extraction is necessary, voltage is applied to the ion extraction device (Operation 210) and the ion extraction device performs ion extraction. Here, the discharge valve and the circulation valve are opened and the pumping device is operated under the condition that the drain valve and the adjustment valves are closed so as to perform circulation of an electrolyte, i.e., first circulation of the electrolyte (Operation S220).

If an energy transfer unit is provided separately from the first circulation, the energy transfer unit is operated so as to apply energy to the electrolyte accommodated in the ion extraction device (Operation S230).

Thereafter, whether or not ion extraction has been completed is judged (Operation S300). Upon judging that ion extraction has been completed, the circulation valve is closed and the adjustment valves are opened under the condition that the drain valve is closed and the discharge valve is opened so as to supply the electrolyte to the decoration device (Operation S310).

Thereafter, whether or not supply of the electrolyte has been completed is judged (Operation S400). Upon judging that supply of the electrolyte has been completed, the drain valve, the discharge valve, the adjustment valves and the circulation valve are closed and the pumping device is turned off (Operation S410).

Thereafter, a target wafer is loaded into the decoration device and voltage is applied to the decoration device so as to perform decoration of the wafer (Operation S420).

Thereafter, whether or not decoration has been completed is judged (Operation S500). Upon judging that decoration has been completed, the drain valve is opened so as to supply the electrolyte discharged from the decoration device to the ion extraction device (Operation S510).

Although the flow chart shown in FIG. 11 illustrates the wafer defecting analysis method as being fed back to Operation S100 after Operation 5510 so as to prepare decoration of the next wafer, Operation 5510 and Operation 5310 may be performed substantially simultaneously.

In order to perform such a process, the ion extraction process within the ion extraction device is continuously performed and the first circulation is continuously performed while the decoration process is performed. Here, the discharge valve and the circulation valve are opened and the adjustment valves are closed.

Simultaneously with supply of the electrolyte discharged from the decoration device to the ion extraction device by opening the drain valve in Operation 5510, the circulation valve may be closed and the adjustment valves may be opened so as to supply the electrolyte within the ion extraction device to the decoration device in Operation 5310.

As apparent from the above description, the wafer defect analysis apparatus, the ion extraction device used therein and the wafer defect analysis method using the same in accordance with the present invention separate a decoration process and an ion extraction process from each other during decoration of defective regions of a wafer and circulate an electrolyte in the ion extraction device, in which ion extraction has been completed, thus minimizing time consumed for the decoration process, thereby greatly reducing an overall time taken to perform decoration and thus shortening a wafer defect analysis time and improving efficiency of defect analysis.

Further, the wafer defect analysis apparatus, the ion extraction device used therein and the wafer defect analysis method using the same in accordance with the present invention improve activity of ions during extraction of the ions for the decoration process, thereby considerably shortening an ion extraction time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wafer defect analysis apparatus comprising:
a decoration device accommodating a designated electrolyte, including a first electrode unit and a second electrode unit, and forming an electric field between the first electrode unit and the second electrode unit so as to achieve ion absorption at defective regions of a wafer mounted on the first electrode unit, wherein the decoration device includes at least one heater to apply heat to the electrolyte so as to increase activity of the ions distributed within the electrolyte;
an ion extraction device accommodating the designated electrolyte, and including a first electrode unit and second electrode unit and a source plate to supply designated ions to the electrolyte by an electric field formed between the first electrode unit and the second electrode unit; and
a circulation device supplying the electrolyte discharged from the decoration device to the ion extraction device and supplying the electrolyte in the ion extraction device, in which ion extraction has been completed, to the decoration device so as to circulate the electrolyte.

2. A wafer defect analysis apparatus comprising:
a decoration device accommodating a designated electrolyte, including a first electrode unit and a second electrode unit, and forming an electric field between the first electrode unit and the second electrode unit so as to achieve ion absorption at defective regions of a wafer mounted on the first electrode unit;
an ion extraction device accommodating the designated electrolyte, and including a first electrode unit and second electrode unit and a source plate to supply designated ions to the electrolyte by an electric field formed between the first electrode unit and the second electrode unit; and
a double circulation device supplying the electrolyte discharged from the decoration device to the ion extraction device, connecting both sides of the ion extraction device so as to circulate the electrolyte within the ion extraction device, and supplying the electrolyte in the ion extraction device, in which ion extraction has been completed, to the decoration device so as to circulate the electrolyte along two routes.

3-4. (canceled)

5. The wafer defect analysis apparatus according to claim 1, wherein the source plate includes a plurality of sub-plates fixed to an electrode pole forming the second electrode unit so as to be separated from each other by a designated interval and having different sizes.

6. The wafer defect analysis apparatus according to claim 5, wherein at least one sub-plate of the plurality sub-plates includes a plurality of holes or corrugated parts so as to increase a surface area of parts of the at least one sub-plate exposed to the electrolyte.

7. (canceled)

8. The wafer defect analysis apparatus according to claim 1, wherein the circulation device includes:
a drain unit connecting the decoration device and the ion extraction device so that the electrolyte is discharged from the decoration device and is then supplied to the ion extraction device; and
a supply unit connecting the ion extraction device and the decoration device so that the electrolyte in the ion extraction device, in which ion extraction has been completed, is supplied to the decoration device.

9. The wafer defect analysis apparatus according to claim 2, wherein the double circulation device includes:
a drain unit connecting the decoration device and the ion extraction device so that the electrolyte is discharged from the decoration device and is then supplied to the ion extraction device;
a supply unit connecting one side of the ion extraction device and the decoration device so that the electrolyte in the ion extraction device, in which ion extraction has been completed, is supplied to the decoration device; and
a circulation unit connecting the supply unit and the other side of the ion extraction device so that the electrolyte is discharged from the one side of the ion extraction device and is then supplied to the other side of the ion extraction device.

10-14. (canceled)

15. The wafer defect analysis apparatus according to claim 1, wherein the ion extraction device further includes an energy transfer unit to transfer designated energy to the electrolyte so as to increase activity of ions supplied from the source plate to the electrolyte.

16. The wafer defect analysis apparatus according to claim 15, wherein:
the source plate includes at least one sub-plate provided with a plurality of holes; and
the energy transfer unit includes a bubble generation unit to supply designated gas to the electrolyte so as to generate bubbles in the electrolyte accommodated in the ion extraction device.

17. (canceled)

18. The wafer defect analysis apparatus according to claim 15, wherein the energy transfer unit includes a stirring unit to stir the electrolyte accommodated within the ion extraction device so as to increase activity of the ions.

19. The wafer defect analysis apparatus according to claim 15, wherein the energy transfer unit includes at least one ultrasonic unit provided on the ion extraction device to transfer ultrasonic waves to the electrolyte accommodated in the ion extraction device so as to increase activity of the ions.

20. The wafer defect analysis apparatus according to claim 15, wherein the energy transfer unit includes at least one heating unit provided on the ion extraction device to transfer heat to the electrolyte accommodated in the ion extraction device so as to increase activity of the ions.

21. An ion extraction device to supply a designated electrolyte to a decoration device, which accommodates the designated electrolyte, includes a first electrode unit and second electrode unit, and forms an electric field between the first electrode unit and the second electrode unit so as to achieve ion absorption at defective regions of a wafer mounted on the first electrode unit, the ion extraction device comprising:
a housing to accommodate the designated electrolyte;
an electrode plate provided on the bottom of the housing;
an insulating member to cover the entirety or a part of the upper surface of the electrode plate;
an electrode pole fixed to the upper end of the housing so as to be opposite to the electrode plate;
a source plate fixed to the electrode pole to supply designated ions to the electrolyte by an electric field formed between the electrode plate and the electrode pole; and
an energy transfer unit to transfer designated energy to the electrolyte so as to increase activity of the ions supplied from the source plate to the electrolyte.

22-24. (canceled)
